(19) United States
(12) Patent Application Publication
(10) Pub. No.: US 2022/0286935 A1
(43) Pub. Date: Sep. 8, 2022

(54) WIRELESS NETWORK PERFORMANCE ANALYSIS

(71) Applicant: ZTE Corporation, Shenzhen (CN)

(72) Inventors: Jianmin FANG, Shenzhen (CN); He HUANG, Shenzhen (CN); Jing LIU, Shenzhen (CN); Zhihong QIU, Shenzhen (CN); Mengjie ZHANG, Shenzhen (CN)

(21) Appl. No.: 17/707,499

(22) Filed: Mar. 29, 2022

Related U.S. Application Data
(63) Continuation of application No. PCT/CN2019/109488, filed on Sep. 30, 2019.

(51) Int. Cl. H04W 36/30; H04W 74/08

(52) U.S. Cl. CPC H04W 36/305; H04W 74/0833

(57) ABSTRACT

Methods, systems, and devices related to digital wireless communication, and more specifically, to techniques related to analyzing wireless network performance. In one exemplary aspect, a method for wireless communication includes receiving, by a network node, a first message including information relating to radio link connection from a terminal. The method may also include performing, by the network node, a network performance analysis based on the information relating to radio link connection.

### CROSS-REFERENCE TO RELATED APPLICATIONS

This application is a continuation of International Patent Application No. PCT/CN2019/109488, filed on Sep. 30, 2019, the contents of which are incorporated herein by reference in their entirety.

### TECHNICAL DOMAIN

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, are being discussed.

### SUMMARY

This document discloses methods, systems, and devices related to digital wireless communication, and more specifically, to techniques related to analyzing wireless network performance.

In one exemplary aspect, a method for wireless communication includes receiving, by a network node, a first message including information relating to radio link connection from a terminal. The method may also include performing, by the network node, a network performance analysis based on the information relating to radio link connection.

In another exemplary aspect, a wireless communications apparatus comprising a processor is disclosed. The processor is configured to implement a method described herein.

In yet another exemplary aspect, the various techniques described herein may be embodied as processor-executable code and stored on a computer-readable program medium.

Some embodiments may preferably implement the following solutions, written in a clause-format.

1. A method for wireless communication, comprising:
receiving, by a network node, a first message including information relating to radio link connection from a terminal; and
performing, by the network node, a network performance analysis based on the information relating to radio link connection.

2. The method of claim 1, wherein the information relating to radio link connection includes information relating to conditional handover.

3. The method of claim 2, wherein the information relating to conditional handover includes one or more conditional handover candidate cell identifiers.

4. The method of claim 2, wherein the information relating to conditional handover includes a trigger condition enforced by the conditional handover.

5. The method of claim 2, wherein the information relating to conditional handover includes a reference parameter of a conditional handover execution target from one or more conditional handover candidate cells.

6. The method of claim 1, wherein the information relating to radio link connection includes information relating to secondary cell group (SCG).

7. The method of claim 6, wherein the information relating to SCG includes an indication that a primary SCG cell of a secondary node (SN) for SN addition is a conditional handover candidate cell.

8. The method of claim 6, wherein the information relating to SCG includes

an indication that a target primary SCG cell of a secondary node for SN change is a conditional handover candidate cell.

9. The method of claim 1, wherein the information relating to radio link connection includes information relating to master cell group (MCG).

10. The method of claim 9, wherein the information relating to MCG includes an indication of whether a target primary cell for master node handover is a candidate cell.

11. The method of claim 1, wherein the information relating to radio link connection includes information relating to connection failure.

12. The method of claim 11, wherein the information relating to connection failure includes an indication of whether the target cell for handover is a conditional handover candidate cell.

13. The method of claim 11, wherein the information relating to connection failure includes an indication of whether the target primary cell for master node handover is a conditional handover candidate cell.

14. The method of claim 11, wherein the information relating to connection failure includes an indication of whether a target PSCell of a secondary node for SN change is a conditional handover candidate cell.

15. The method of claim 11, wherein the information relating to connection failure includes a connection failure type, and a value of the connection failure type is indicative of master cell group recovery failure.

16. The method of claim 11, wherein the information relating to connection failure includes a radio link failure cause, and a value of the radio link failure cause is indicative of master cell group recovery failure.

17. The method of claim 11, wherein the information relating to connection failure includes an indication of whether a master cell group recovery failure has occurred.

18. The method of claim 11, wherein the information relating to connection failure includes a cause for a master cell group recovery failure.

19. The method of claim 11, wherein the information relating to connection failure includes a master cell group recovery timer duration.

20. The method of claim 11, wherein the information relating to connection failure includes an indication of whether a handover target cell during a master cell group recovery process is a conditional handover candidate cell.

21. The method of claim 11, wherein the information relating to connection failure includes a master cell group (MCG) failure information reported solution.

22. The method of claim 11, wherein the information relating to connection failure includes an MCG failure information reported signaling radio bearer (SRB).

23. The method of claim 11, wherein the information relating to connection failure includes an indication of whether the re-establishment cell is a conditional handover candidate cell.

24. The method of claim 1, wherein the information relating to radio link connection includes information relating to random access channel (RACH) procedure including one or more RACH attempts.

25. The method of claim 24, wherein the information relating to RACH procedure includes a fallback number between a 2-step RACH attempt and a 4-step RACH attempt per RACH procedure.

26. The method of claim 24, wherein the information relating to RACH procedure includes a fallback number between a 2-step RACH attempt and a 4-step RACH attempt per beam.

27. The method of claim 24, wherein the information relating to RACH procedure includes an indication of whether a maximum transmission power is used for transmission of a PUSCH payload for a 2-step RACH attempt per RACH procedure.

28. The method of claim 24, wherein the information relating to RACH procedure includes an indication of whether a maximum transmission power is used for transmission of a PUSCH payload for a 2-step RACH attempt per beam.

29. The method of claim 24, wherein the information relating to RACH procedure includes a maximum power level for transmission of a PUSCH payload for a 2-step RACH attempt per RACH procedure.

30. The method of claim 24, wherein the information relating to RACH procedure includes a maximum power level used for transmission of a PUSCH payload for a 2-step RACH attempt per beam.

31. The method of claim 24, wherein the information relating to RACH procedure includes number of preamble transmission power ramping on each beam.

32. The method of claim 1, wherein the first message is a secondary cell group failure information message that includes information relating to secondary cell group and/or information relating to conditional handover.

33. The method of claim 1, wherein the first message is a master cell group failure information message that includes information relating to master cell group and/or information relating to conditional handover.

34. The method of claim 1, wherein the first message is a user equipment (UE) information response message that includes at least one of information relating to connection failure, information relating to conditional handover, information relating to RACH procedure.

35. The method of claim 1, further comprising: responsive to receiving the first message, forwarding, by the network node, a second message to a secondary node including the information relating to secondary cell group and/or information relating to conditional handover, the network node including a master node.

36. The method of claim 1, further comprising: responsive to receiving the first message, forwarding, by the network node, a second message including at least one of information relating to connection failure, information relating to conditional handover, and information relating to RACH procedure, to another network node serving a source cell associated with handover.

37. The method of claim 1, further comprising: responsive to receiving the first message, forwarding, by the network node, a second message including at least one of information relating to connection failure, information relating to conditional handover, and information relating to RACH procedure, to another network node serving a cell in which a connection failure occurred.

38. The method of claim 37, wherein the network node serving a cell in which a connection failure occurred forwards the received information including at least one of information relating to connection failure, information relating to conditional handover, and information relating to RACH procedure to another network node serving a source cell associated with handover.

39. The method of claim 1, wherein the network node includes a secondary node, wherein the secondary node performs the network performance analysis.

40. The method of claim 1, wherein the network performance analysis is performed by a network node serving a source cell associated with handover.

41. An apparatus for wireless communication comprising a processor that is configured to carry out the method of any of methods 1 to 40.

42. A non-transitory computer readable medium having code stored thereon, the code when executed by a processor, causing the processor to implement a method recited in any of methods 1 to 40.

The details of one or more implementations are set forth in the accompanying attachments, the drawings, and the description below. Other features will be apparent from the description and drawings, and from the clauses.

### BRIEF DESCRIPTION OF THE DRAWINGS

FIG. 1 illustrates a block diagram of an example 5G network architecture.

FIG. 2 illustrates a block diagram of a Dual Connectivity (DC) schematic.

FIG. 3 illustrates a signaling process for measurement result reporting.

FIG. 4 illustrates a signaling process for performing network analysis according to a first example embodiment.

FIG. 5 illustrates a signaling process for performing network analysis according to a second example embodiment.

FIG. 6 illustrates a signaling process for performing network analysis according to a third example embodiment.

FIG. 7 illustrates a signaling process for performing network analysis according to a fourth example embodiment.

FIG. 8 illustrates a signaling process for performing network analysis according to a fifth example embodiment.

FIG. 9 illustrates a signaling process for performing network analysis according to a sixth example embodiment.

FIG. 10 illustrates a signaling process for performing network analysis according to a seventh example embodiment.

FIG. 11 illustrates a signaling process for performing network analysis according to an eighth example embodiment.

FIG. 12 illustrates a signaling process for performing network analysis according to a ninth example embodiment.

FIG. 13 illustrates a signaling process for performing network analysis according to a tenth example embodiment.

FIG. 14 illustrates a block diagram of a method to analyze network performance.

FIG. 15 shows an example of a wireless communication system where techniques in accordance with one or more embodiments of the present technology can be applied.

FIG. 16 is a block diagram representation of a portion of a hardware platform.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

The development of the new generation of wireless communication—5G New Radio (NR) communication—is a part of a continuous mobile broadband evolution process to meet the requirements of increasing network demand. NR will provide greater throughput to allow more users connected at the same time. Other aspects, such as energy consumption, device cost, spectral efficiency, and latency are also important to meeting the needs of various communication scenarios.

### Overview

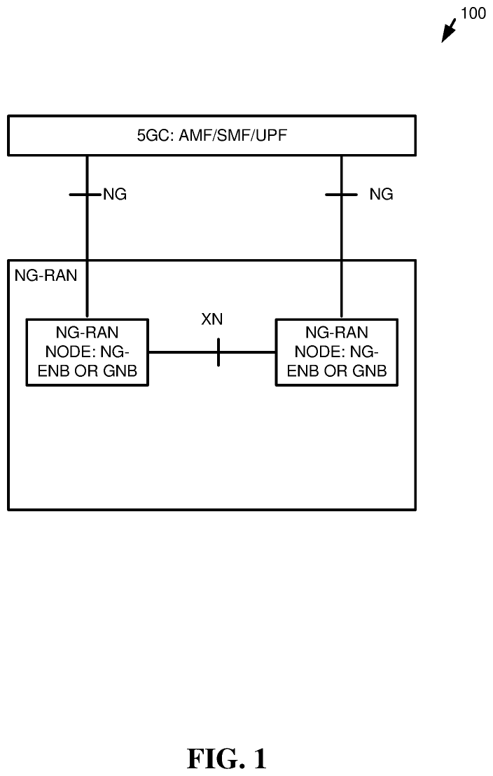

FIG. 1 illustrates a block diagram 100 of an example 5G network architecture. As shown in FIG. 1, a fifth generation (5G) network architecture may include a 5G core network (5GC) and a next generation radio access network (NG-RAN).

The 5GC may include any of an Access Mobility Function (AMF), a Session Management Function (SMF), and a User Plane Function (UPF). NG-RAN may include base stations with different radio access technologies (RATs), such as an evolved 4G base station (ng-eNB), and a 5G base station (gNB). The NG-RAN base station may be connected to the 5GC through the NG interface, and the NG-RAN base stations may be connected through the Xn interface.

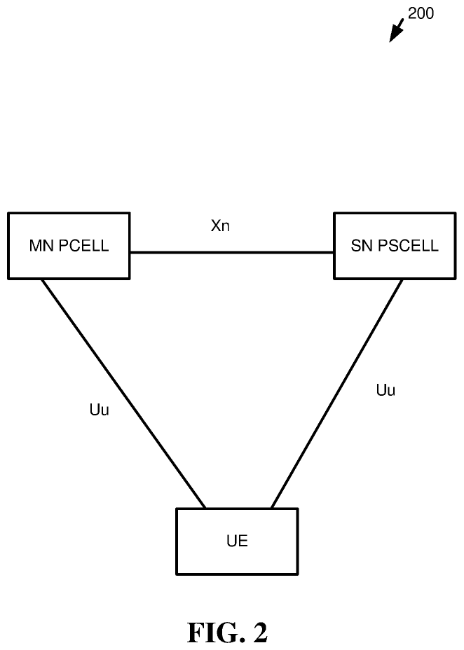

FIG. 2 illustrates a block diagram 200 of a Dual Connectivity (DC) schematic. As shown in FIG. 2, various networks (e.g., 4G and 5G systems) may support Dual Connectivity (DC) functionality. A DC enabled UE may remain connected simultaneously with two base stations, wherein a first base station may be a Master Node (MN), and a second base station is a Secondary Node (SN). Participation of a DC enabled cell located at MN may include a Master Cell Group (MCG) including a Primary Cell (PCell), and the secondary station may include a secondary cell group (SCG) including a primary SCG Cell (PSCell). The base station and the terminal UE may be connected through a Uu air interface.

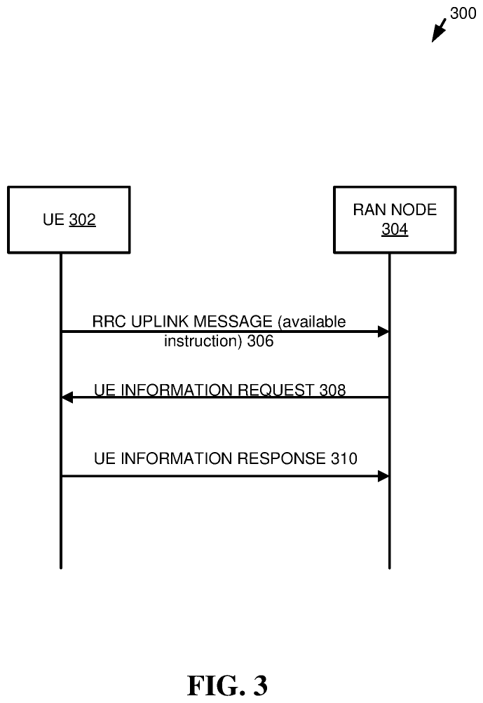

FIG. 3 illustrates a signaling process 300 for measurement result reporting. The UE may provide a base station (e.g., RAN node) measurement result reporting information.

As shown in FIG. 3, the UE 302 may send RRC uplink message 306 to the RAN node 304. The RRC uplink message may include an available indication. The RAN node 304 may send a UE information request 308 to the UE 302. The UE 302 may transmit a UE information response 310 to the RAN node 304 in response to receiving the UE information request.

### System Overview

The present embodiments relate to analyzing wireless network performance. A network node may receive information relating to at least one report reported by the UE. The report may include at least one of conditional handover (CHO) related information, SCG related information, MCG related information, Connection Failure related information, RACH procedure related information. The CHO related information may include at least one of one or more CHO candidate cell identifiers, number of CHO candidate cells, a trigger condition of CHO execution, a reference condition of CHO target selection.

The trigger condition of CHO execution may include at least one of an identification of reference signal, a type of reference signal (RS type) (e.g., synchronization signal/physical broadcast channel block (SSB), Channel State Information Reference Signal (CSI-RS)), a measurement quantity (e.g., Reference Signal Received Power (RSRP), Reference Signal Received Quality (RSRQ), signal-to-noise and interference ratio (SINR)), a threshold.

The reference condition of CHO target selection (i.e. reference condition UE considers when UE selects the CHO execution target from multiple CHO candidate cells) may include at least one of a reference beam identifier, reference beam type (e.g., SSB, CSI-RS), reference beam measurement value (e.g., RSRP value, RSRQ value, SINR value), a comparison rule (e.g., comparing only a best beam, comparing plurality of beams above a threshold, threshold, number of beams above a threshold).

The SCG related information may include at least one of a PSCell identifier in case of SN Addition process, an indication whether the PSCell is a CHO candidate cell in case of SN Addition process, a SN change target PSCELL identifier, and an indication whether the target PSCELL is a CHO candidate cell in case of SN change process.

The MCG related information may include at least one of a reason for MCG Failure (such as MN handover failure, RLF), an identity of the target PCell of the MN handover, and an indication of whether the target PCell of the MN handover is a CHO candidate cell.

The Connection Failure related information may include at least one of an identity of the handover target cell, an indication of whether the handover target cell is a CHO candidate cell, a reason for MCG failure (such as MN handover failure, RLF), an identity of the target PCell of the MN handover, an indication of whether the target PCell of the MN handover is the CHO candidate cell, a SN change target PSCell identifier, an indication of whether the target PSCell of the SN change is a CHO candidate cell, a Connection Failure Type (such as MCG recovery failure), a RLF Cause (e.g., MCG recovery failure), an indication of whether MCG recovery failure has occurred, a cause of the MCG recovery failure (such as the handover initiated by the MN during the MCG recovery process is failed, the MCG recovery timer expires), a MCG recovery timer duration, an identity of the handover target cell during the MCG recovery process, an indication of whether the handover target cell during the MCG recovery process is a CHO candidate cell, a MCG failure Information reported solution, a MCG failure information reported path, a MCG Failure Information reported SRB, an identity of the Re-establishment cell, an indication of whether the Re-establishment cell is a CHO candidate cell.

The MCG failure Information reported solution may include using a single message or using duplicated messages (e.g., sending two identical messages).

The MCG failure information reported path may include reporting to the MN only via the MCG SCELL, reporting to the MN only via the SN, or reporting to the MN via both the MCG SCELL and the SN.

The MCG Failure Information reported SRB may include through SRB1 only, through SRB3 only, through SRB1 and SRB3 (may indicate that one message is sent on SRB1, and another identical message is sent on SRB3), through the MCG Leg of Split SRB1 only, through the SCG leg of Split SRB1 only, through the MCG leg of Split SRB1 and SRB3 (may indicate that one message is sent on the MCG leg of Split SRB1 and another identical message is sent on the SRB3), through the SCG leg of Split SRB1 and SRB3 (may indicate that one message is sent on the SCG leg of Split SRB1 and another identical message is sent on the SRB3), through the MCG leg of Split SRB1 and SCG leg of Split SRB1 (may indicate that one message is sent on the MCG leg of Split SRB1 and another identical message is sent on the SCG leg of Split SRB1), or through the MCG leg of split SRB1 and SCG leg of split SRB1 and SRB3 (may indicate that one message is sent on the MCG leg of Split SRB1, another identical message is sent on the SCG leg of Split SRB1, and another identical message is sent on the SRB3).

The RACH procedure related information may include at least one of number of fallback between 2-step RACH and 4-step RACH per RACH Procedure, number of fallback between 2-step RACH and 4-step RACH per Beam, an indicator to indicate Fallback Between 2-step RACH and 4-step RACH Per RACH procedure (which may be set to true if 2-Step RACH at least fallback to 4-step RACH once during a RACH procedure), an indicator to indicate fallback between 2-step RACH and 4-step RACH per Beam (which may be set to true if 2-step RACH at least fallback to 4-step RACH once related to a Beam During a RACH procedure), number of PUSCH transmission occasion (PO) selected per Beam, a PO index selected per Beam (Listed in chronological order of attempts), an indicator to indicate whether the maximum transmission power is used for transmission of PUSCH payload of 2-step RACH per RACH procedure, an indicator to indicate whether the maximum transmission power is used for transmission of PUSCH payload of 2-step RACH per PO, and an indicator to indicate whether the maximum transmission power is used for transmission of PUSCH payload of 2-step RACH per Beam (for example, if the maximum transmission power is used for transmission of PUSCH payload of 2-step RACH in at least one PO mapped to this Beam, where the maximum transmission power is used for this Beam), a maximum power level used for transmission of PUSCH payload of 2-step RACH per RACH procedure, a maximum power level used for transmission of PUSCH payload of 2-step RACH per PO, a maximum power level used for transmission of PUSCH payload of 2-step RACH per Beam (in case Multiple PO is mapped to One Beam, it may be a list of maximum power level in Each PO, or the maximum power level among all PO), number of power ramping in each PO for transmission of PUSCH payload of 2-step RACH, number of preamble transmission power ramping on each beam, and a maximum preamble transmission power on each beam.

The RACH procedure related information may include 2-step RACH related information and/or 4-step RACH related information.

The 2-step RACH related information may include at least one of number of fallback between 2-step RACH and 4-step RACH per RACH Procedure, number of fallback between 2-step RACH and 4-step RACH per Beam, an indicator to indicate Fallback Between 2-step RACH and 4-step RACH Per RACH procedure (which may be set to true if 2-Step RACH at least fallback to 4-step RACH once during a RACH procedure), an indicator to indicate fallback between 2-step RACH and 4-step RACH per Beam (which may be set to true if 2-step RACH at least fallback to 4-step RACH once related to a Beam During a RACH procedure), number of PUSCH transmission occasion (PO) selected per Beam, a PO index selected per Beam (Listed in chronological order of attempts), an indicator to indicate whether the maximum transmission power is used for transmission of PUSCH payload of 2-step RACH per RACH procedure, an indicator to indicate whether the maximum transmission power is used for transmission of PUSCH payload of 2-step RACH per PO, and an indicator to indicate whether the maximum transmission power is used for transmission of PUSCH payload of 2-step RACH per Beam (for example, if the maximum transmission power is used for transmission of PUSCH payload of 2-step RACH in at least one PO mapped to this Beam, where the maximum transmission power is used for this Beam), a maximum power level used for transmission of PUSCH payload of 2-step RACH per RACH procedure, a maximum power level used for transmission of PUSCH payload of 2-step RACH per PO, a maximum power level used for transmission of PUSCH payload of 2-step RACH per Beam (in case Multiple PO is mapped to One Beam, it may be a list of maximum power level in Each PO, or the maximum power level among all PO), number of power ramping in each PO for transmission of PUSCH payload of 2-step RACH, number of preamble transmission power ramping on each beam, and a maximum preamble transmission power on each beam, number of fallback between 2-step CFRA to 2-step CBRA per RACH procedure, number of fallback between 2-step CFRA to 2-step CBRA per beam, number of preambles sent on each beam and the beam indices, indexes of tried beams and number of preambles sent on each tried beam listed in chronological order of attempts, contention detected indication per beam (wherein the contention detected indication is set as true if at least one failed contention resolution is detected in this beam), backoff related information (e.g. number of backoff with value larger than 0 used during RACH attempt utilizing RACH resource configured for 2-step RACH, or list of backoff value used during RACH attempt utilizing RACH resource configured for 2-step RACH, or maximum backoff value used during RACH attempt utilizing RACH resource configured for 2-step RACH), number of preambles sent in each preamble group per RACH procedure, number of preambles sent in each preamble group per beam, indication to indicate which group of preamble is selected per RACH procedure (such group A, group B, or both), indication to indicate which group of preamble is selected per beam (such group A, group B, or both), indication to indicate which type of beam is selected per RACH procedure (such as SSB, CSI-RS, or both), list of type of beam selected in chronological order per RACH procedure.

The 4-step RACH related information may include at least one of number of preamble transmission power ramping on each beam, maximum preamble transmission power on each beam, number of fallback between CFRA to 4-step CBRA per RACH procedure, number of fallback between CFRA to 4-step CBRA per beam, number of preambles sent on each beam and the beam indices, indexes of tried beams and number of preambles sent on each tried beam listed in chronological order of attempts, contention detected indication per beam (wherein the contention detected indication is set as true if at least one failed contention resolution is detected on this beam), backoff related information (e.g. number of backoff with value larger than 0 used during RACH attempt utilizing RACH resource configured for 4-step RACH, or list of backoff value used during RACH attempt utilizing RACH resource configured for 4-step RACH, or maximum backoff value used during RACH attempt utilizing RACH resource configured for 4-step RACH), number of preambles sent in each preamble group per RACH procedure, number of preambles sent in each preamble group per beam, indication to indicate which group of preamble is selected per RACH procedure (such group A, group B, or both), indication to indicate which group of preamble is selected per beam (such group A, group B, or both), indication to indicate which type of beam is selected per RACH procedure (such as SSB, CSI-RS, or both), list of type of beam selected in chronological order per RACH procedure.

The network node may perform wireless network performance analysis according to the received information. The wireless network performance analysis may include analysis of CHO configuration parameters, determining whether the MCG Recovery Timer configuration is a reasonable length, whether there is the problem that the uplink signal is not good, and determining whether the RACH configuration parameter is reasonable.

A SCG failure information message may be received that includes SCG related information and/or CHO related information.

An MCG failure information message may be received that includes MCG related information and/or CHO related information.

The base station may receive a UE information response message from the UE reporting the connection failure related information and/or CHO related information and/or RACH procedure related information.

The base station (e.g., MN) may forward the received SCG related information and/or CHO related information reported by the UE to the SN (e.g., by a SCG FAILURE INDICATION message).

The connection failure related information and/or CHO related information and/or RACH procedure related information reported by the UE received by the base station may be forwarded to another base station to which the source cell of the handover belongs (e.g., via an RLF INDICATION message).

The connection failure related information and/or CHO related information and/or RACH procedure related information reported by the UE received by the base station may be forwarded to another base station serving the cell in which the Connection Failure occurs (e.g., via an RLF INDICATION message).

The base station serving the cell in which the connection failure occurs may forward the connection failure related information and/or CHO related information and/or RACH procedure related information to another base station to which the source cell of the handover belongs (e.g., through the HO REPORT message).

The wireless network performance analysis may be performed in the SN.

The wireless network performance analysis may be performed in the base station to which the handover source cell belongs.

The wireless network performance analysis may be performed in the base station serving the cell in which the Connection Failure occurs.

The wireless network performance analysis may be performed in the base station who receives the related information reported by the UE.

The network node, according to the received information reported by the UE, may perform the wireless network performance analysis (e.g., analysis of CHO configuration parameters, the MCG Recovery Timer configuration length, whether there is a problem that the uplink signal is not good, a RACH configuration parameter).

### Example Embodiment 1

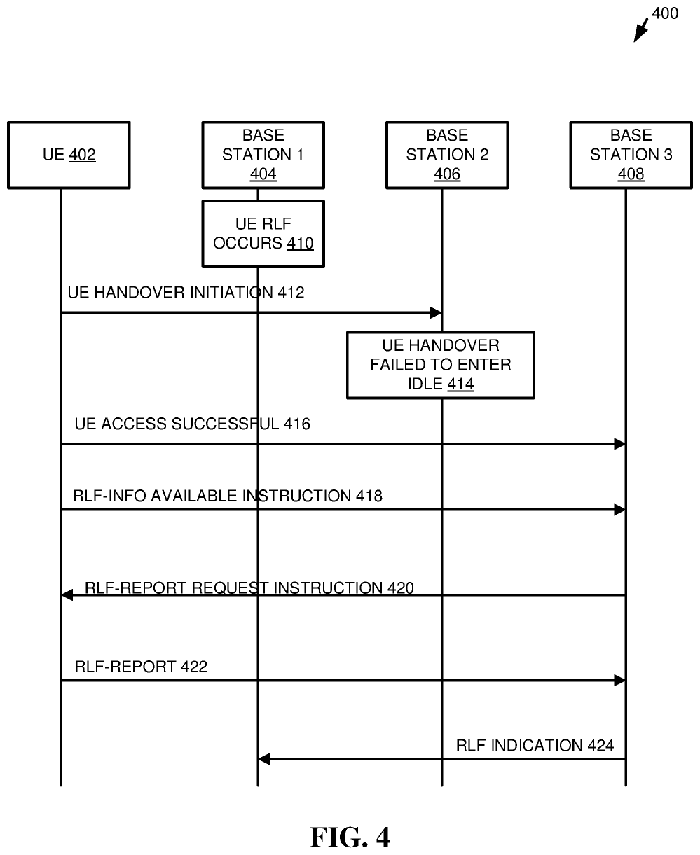

FIG. 4 illustrates a signaling process 400 for performing network analysis according to a first example embodiment. As shown in FIG. 4, both RLF and CHO may fail.

In step 410, a UE 402 may occur a radio link failure (RLF) in a cell 1 of the base station 1 404.

In step 412, UE 402 may send a UE handover initiation to a second base station 406. The UE may select cell 2 of base station 2 406 for cell selection. cell 2 of Base station 2 406 may be a CHO candidate cell configured to initiate a conditional handover to the UE 402. The UE 402 may initiate a handover to the cell 2 of base station 2 406.

In step 414, UE may be failed to handover to base station 2 406 to enter idle state. The UE may occur a handover failure, and the UE may enter an RRC_IDLE state.

In step 416, the UE may access successfully to a third base station 408. The UE may select cell 3 of base station 3 for cell selection, the UE may successfully access the cell 3 of base station 3 and enter the RRC_CONNECTED state.

In step 418, the UE 402 may send an RLF-info available instruction to the base station 3 408 through the RRC uplink message.

In step 420, base station 3 408 may send a UEInformationRequest message to the UE 402 to carry the rlf-ReportReq indication.

In step 422, the UE may send an RLF-report to base station 3 408. The RLF report may include any of a Re-establishment Cell (in this case: the cell 2 of base station 2 406) identification, an indication indicates whether the Re-establishment Cell is the CHO candidate cell (in this case: yes), one or more CHO candidate cell identifiers, number of CHO candidate cells, a trigger condition of CHO execution (e.g., an identification of reference signal, a type of reference signal RS type (SSB, CSI-RS), a measurement quantity (RSRP, RSRQ, SINR), threshold), a reference condition of CHO target selection (i.e. reference condition UE considers when UE selects the CHO execution target from multiple CHO candidate cells) (such as a reference beam identifier, a reference beam type (SSB, CSI-RS), reference beam measurement value (RSRP value, RSRQ value, SINR value), a comparison rule (only compare Best beam, comparing the plurality of beams above threshold, threshold, beam number above the threshold)).

In step 424, base station 3 408 may send an RLF indication to base station 1 404 to carry the content of the RLF-report.

### Example Embodiment 2

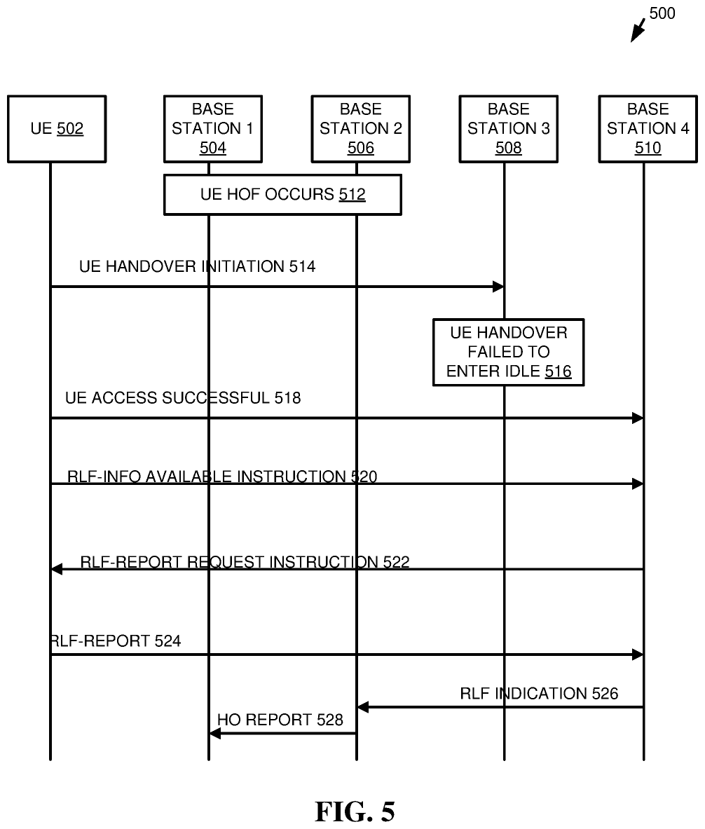

FIG. 5 illustrates a signaling process 500 for performing network analysis according to a second example embodiment. As shown in FIG. 5, both handover failure and CHO may fail.

In step 512, UE handover failure (HOF) occurs. During UE 502 handover from the cell 1 of base station 1 504 to the cell 2 of base station 2 506 the HOF failure occurs. The cell 2 of base station 2 506 may be a CHO candidate cell, and the handover of the UE from cell 1 of base station 1 to cell 2 of base station 2 may be a conditional handover.

In step 514, the UE 502 may send a UE handover initiation message to the base station 3 508. The UE may select the cell 3 of base station 3 508 for Cell Selection, where the cell 3 of base station 3 may be a CHO candidate cell, and the UE may initiate handover to the cell 3 of base station 3.

In step 516, the UE handover fails to enter an idle state. The UE may occur the handover failure, and the UE may enter the RRC_IDLE state.

In step 518, the UE 502 may access successfully to base station 4 510. The UE may select and successfully access cell 4 of base station 4, and the UE may enter a RRC_CONNECTED state.

In step 520, the UE may send a rlf-InfoAvailable indication to the base station 4 510 through the RRC uplink message.

In step 522, base station 4 510 may send a UEInformationRequest message to the UE to carry the rlf-ReportReq indication.

In step 524, the UE to the base station 4 may transmit a UEInformationResponse message carrying the RLF-the Report.

The RLF-Report may include at least one of the following: an indication whether the handover target cell (in this case: the cell 2 of base station 2) is a CHO candidate cell (in the present For example: yes), an identifier of the re-establishment cell (in this example: the cell 3 of base station 3), an indication of whether the re-establishment cell is the CHO candidate cell (in this example: yes), one or more CHO candidate cells, number of CHO candidate cells, a trigger condition of CHO execution, a reference condition of CHO target selection.

In step 526, base station 4 may send an RLF INDICATION message to the base station 2 to carry the content of the rlf-Report.

In step 528, base station 2 may send a message (such as HO REPORT) to the base station 1 to carry the content of the rlf-Report.

### Example Embodiment 3

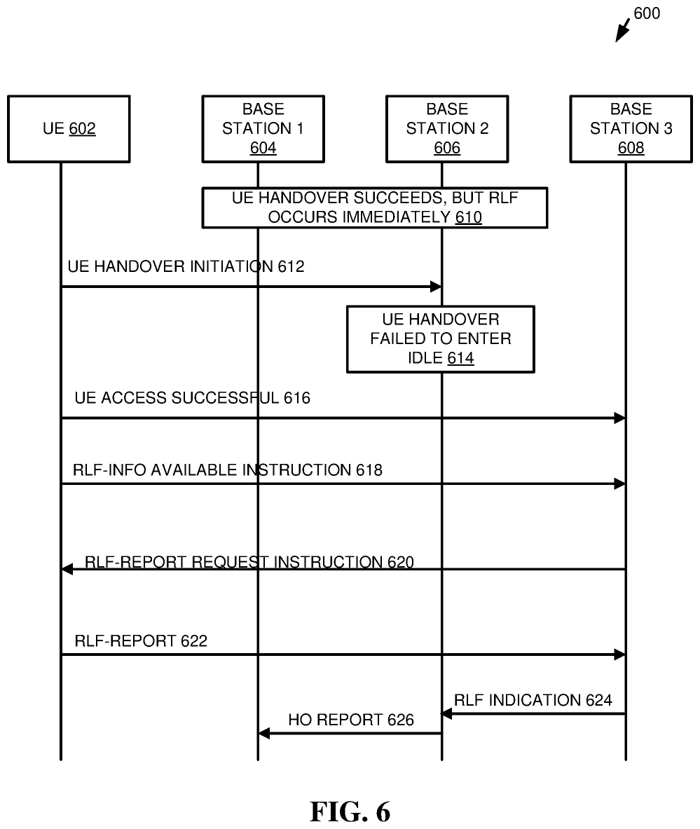

FIG. 6 illustrates a signaling process 600 for performing network analysis according to a third example embodiment. As shown in FIG. 6, HOF, RLF, and CHO may fail.

In step 610, the UE handover may succeed, but RLF may occur immediately. The UE from the cell 1 of base station 1 may have a successful handover to the cell 2 of base station 2, where the cell 2 of base station 2 is a CHO candidate cell. The UE handover from cell 1 of base station 1 to cell 2 of base station 2 is a conditional handover. However, UE may be immediately placed to radio link failure RLF (i.e., RLF occurs within a predetermined time period after the handover).

In step 612, UE 602 sends a UE handover initiation to base station 606. The UE may perform cell selection, selects the cell 3 of base station 2, and the cell 3 of base station 2 is a CHO candidate cell, and the UE initiates handover to the cell 3 of base station 2.

In step 614, the UE handover failed to enter idle. The UE may occur the handover failure, and the UE may enter the RRC_IDLE state.

In step 616, the UE may access successfully to base station 3. The UE may perform cell selection and selects a cell 4 of the base station 3, and the UE can access the cell 4 successfully and enter the RRC_CONNECTED state.

In step 618, UE may send a rlf-InfoAvailable indication to the base station 3 through the RRC uplink message.

In step 620, the base station 3 may send a UEInformationRequest message to the UE to carry the rlf-ReportReq indication.

In step 622, the UE to the base station 3 transmits UEInformationResponse message carrying the RLF-the Report. The RLF-Report may include at least one of the following: an indication whether the handover target cell (in this case: the cell 2 of base station 2) is a CHO candidate cell (in the present For example: yes), an identifier of the re-establishment cell (in this example: the cell 3 of base station 2), an indication of whether the re-establishment cell is the CHO candidate cell (in this example: yes), one or more CHO candidate cells, number of CHO candidate cells, a trigger condition of CHO execution, a reference condition of CHO target selection.

In step 624, base station 3 sends a message (such as RLF INDICATION) to the base station 2 to carry the contents of the rlf-Report.

In step 626, base station 2 sends a message (such as HO REPORT) to the base station 1 to carry the content of the rlf-Report.

### Example Embodiment 4

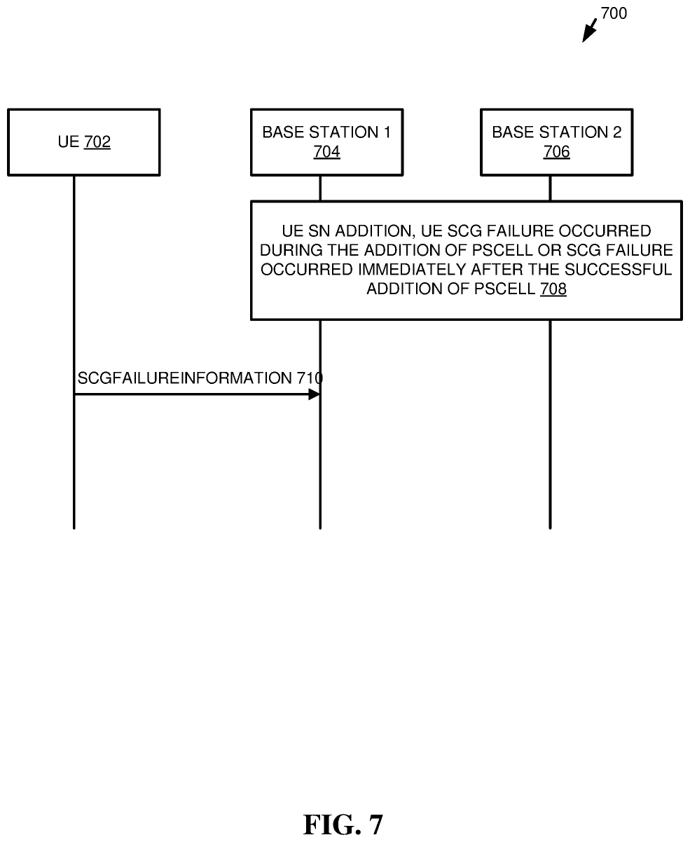

FIG. 7 illustrates a signaling process 700 for performing network analysis according to a fourth example embodiment. As shown in FIG. 7, SN addition fails.

In step 708, UE SN Addition, UE SCG failure occurred during the addition of PSCell or SCG failure occurred immediately after the successful addition of PSCell. The UE's current serving cell is the cell 1 of the base station 1, the cell 2 of base station 2 is a CHO candidate cell, the UE attempt to add the cell 2 of base station 2 as a PSCell for SN Addition, the UE occurs SCG failure during Addition of PSCell, or the UE successfully added PSCell, but the UE immediately in base station 2 in place SCG failure (i.e., SCG failure occurs within a predetermined time period after PSCell is added).

In step 710, UE 702 sends SCGfailureinformation to base station 1 704. The SCG failure Information may include at least one of the following: indication of whether the PSCell of SN Addition (in this case: the cell 2 of base station 2) is a CHO candidate cell (In this example, yes), one or more CHO candidate cell identifiers, number of CHO candidate cells, a trigger condition of CHO execution, a reference condition of CHO target selection.

### Example Embodiment 5

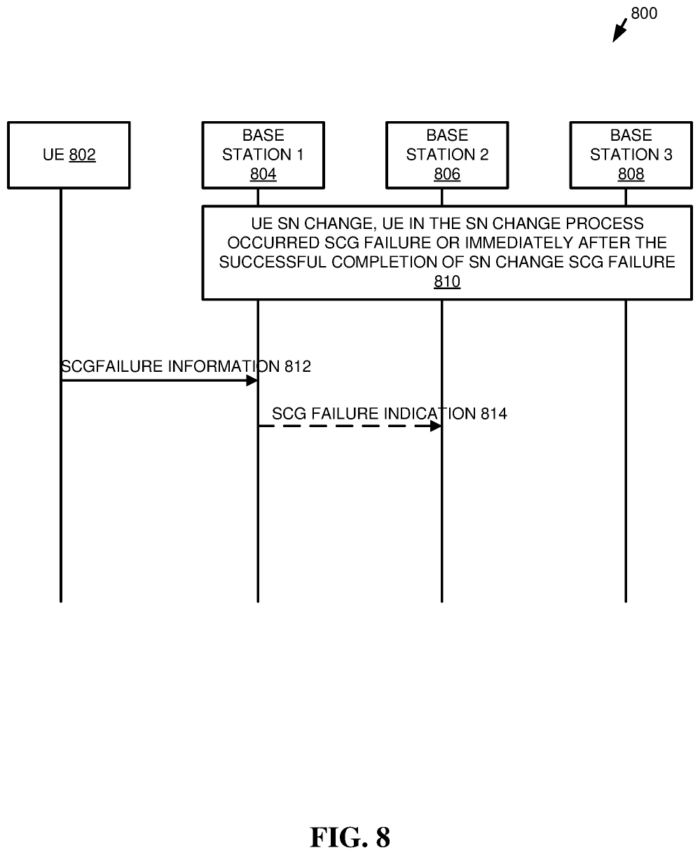

FIG. 8 illustrates a signaling process 800 for performing network analysis according to a fifth example embodiment. As shown in FIG. 8, a SN change fails.

In step 810, UE SN change, UE in the SN change process occurred SCG failure or immediately after the successful completion of SN change UE occurred SCG failure. The UE may be in the DC state, the cell 1 of base station 1 may be the PCell, the cell 2 of base station 2 may be the PSCell, the cell 3 of base station 3 is the CHO candidate cell, the UE attempts to access to the cell 3 of base station 3 as a target PSCell for SN change. The UE occurred SCG failure during in the SN change, or, UE successfully completed SN change, but the UE immediately in the base station 3 in place SCG failure, i.e. SCG failure occurred after the SN change within a preset time.

In step 812, the UE 802 may send SCG failure information to base station 1 804. SCG failure information may include at least one of: indication of whether the SN Change target PSCell (in this case: the cell 3 of base station 3) is the CHO candidate cell (This example is: yes), one or more CHO candidate cell identifiers, the number of CHO candidate cells, a trigger condition of CHO execution, a reference condition of CHO target selection.

In step 814, the base station 1 804 may send a SCG failure indication to base station 2 806. When a SN Change is triggered by SN, the base station 1 may send a message (e.g., the SCG FAILURE INDICATION) carrying the SCG failure information content to base station 2.

### Example Embodiment 6

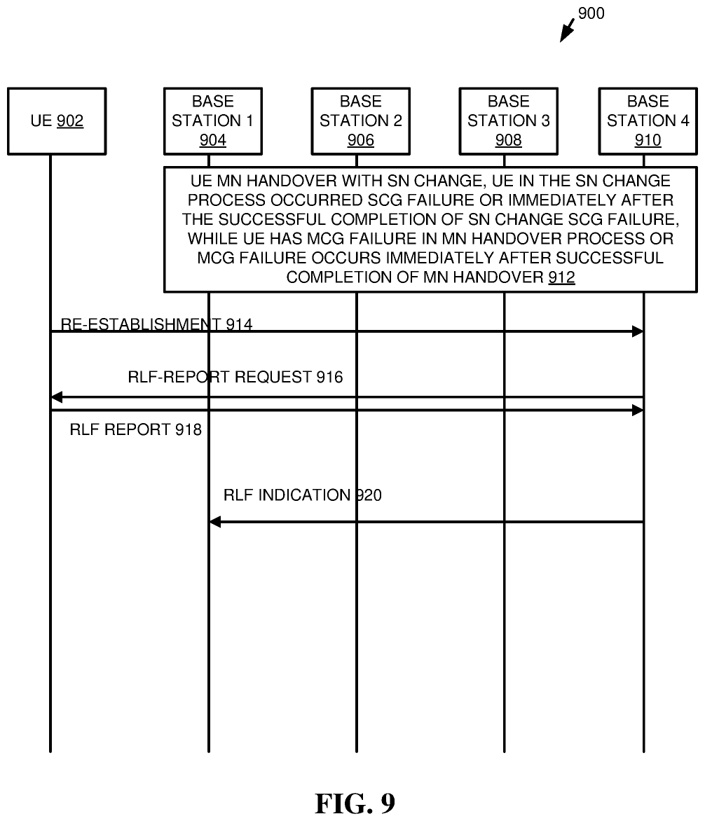

FIG. 9 illustrates a signaling process 900 for performing network analysis according to a sixth example embodiment. As shown in FIG. 9, a MN handover with a SN change may fail.

In step 912, the UE may be in the DC state, the cell 1 of base station 1 may be the PCell, the cell 2 of base station 2 is PSCell, the cell 3 of base station 3 and the cell 4 of base station 4 may be CHO candidate cells. The UE may perform MN handover with SN change and cell 3 of base station 3 may be the PCell and the cell 4 of base station 4 may be the PSCell. The UE may have a SCG failure during the SN change, or the UE may successfully complete the SN change, but the UE may immediately have the SCG failure in base station 4. The UE may have MCG failure during the MN handover, or UE may successfully complete MN handover, but the UE immediately have an MCG failure occur at base station 3, where MCG failure may occur within a preset time after the MN handover.

In step 914, the UE 902 may send a re-establishment message to base station 4 910 to successfully access the cell 5 of base station 4 910.

In step 916, the UE 902 may receive RLF-report request from the base station 4 910.

In step 918, the UE may send an RLF report to base station 4 910. The RLF-the Report may include at least one of: indication of whether the MN HANDOVER target PCell (in this case: the cell 3 of base station 3) is the CHO candidate cell (This example is: YES), indication of whether the target PSCell of SN change (in this example: cell 4 of base station 4) is the CHO candidate cell (in this example: yes), re-establishment cell (in this example: cell 5 of base station 4) identifier, indication of whether the re-establishment cell is the CHO candidate cell (in this example: no), one or more CHO candidate cell identifiers, number of CHO candidate cells, a trigger condition of CHO execution, a reference condition of CHO target selection.

In step 920, base station 4 may send a message (such as RLF INDICATION) to the base station 1 to carry the content of the rlf-Report.

### Example Embodiment 7

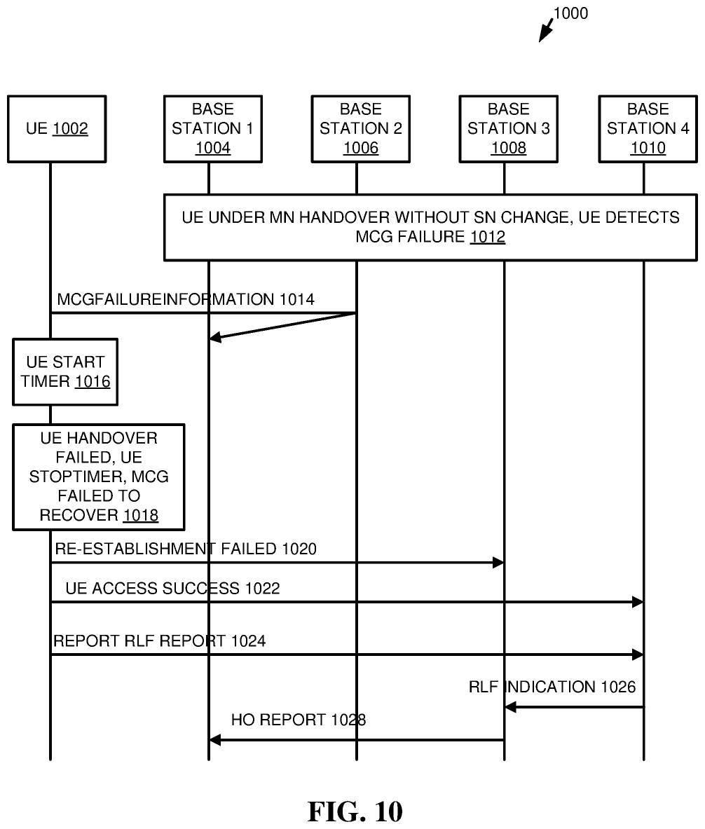

FIG. 10 illustrates a signaling process 1000 for performing network analysis according to a seventh example embodiment. As shown in FIG. 10, CHO and MCG recovery may fail.

In step 1012, the UE may be in the DC state, the cell 1 of base station 1 may be the PCell, the cell 2 of base station 2 may be PSCell, the cell 3 of base station 3 may be the CHO candidate cell, the UE for MN handover without SN change may take cell 3 as the target PCell, and the UE may have HOF during the MN handover.

In step 1014, the UE 1002 may send an MCG failure information message to the base station 2 1006, where the message is forwarded to the base station 1 1004. The MCG failure information may carry at least one of: MCG failure cause (in this case: the MN HANDOVER failure), MN HANDOVER target (In this example, the identifier of the cell 3 of the base station 3), an indication of whether the target PCell of the MN handover is the CHO candidate cell (in this example: yes), one or more CHO candidate cell identifiers, number of CHO candidate cells, a trigger condition of CHO execution, a reference condition of CHO target selection.

In step 1016, the UE may start the configured timer.

In step 1018, UE may initiate handover to the cell 4 of the base station 3 (the handover command sent by the base station 1 through the base station 2), but fails, the UE may stop the timer, and the MCG failure of the UE may not be restored.

In step 1020, the UE may initiate a re-establishment to the cell 5 of the base station 3, but fails, and the UE may enter the RRC_IDLE state.

In step 1022, UE may perform cell selection, selects the cell 6 of the base station 4, the UE accesses the cell 6, and the UE enters the RRC_CONNECTED state.

In step 1024, UE to the base station 4 may report the RLF-the Report. The RLF-Report contains at least one of the following: Connection Failure Type (in this case: the MCG Recovery failure), MCG Recovery failure cause (in this case: during the MCG Recovery process performing MN issued handover failure), MCG failure cause (in this case: MN handover failure), MN handover target PCell (in this case: the cell 3 of base station 3) identification, indication of whether the MN handover target Pcell is the CHO candidate cell (in this example: yes), duration of the MCG recovery timer, identity of the handover target cell (in this example, the cell 4 of the base station 3) during the MCG recovery process, MCGFailureInformation reported solution (This example: using a Single message), MCGFailureInformation reported path (This example: reporting to the MN only via the SN), the MCGFailureInformation reported SRB (This example is: through the SCG leg of split SRB1).

In some embodiments, the RLF-report may include any of re-establishment cell (in this example, the cell 5 of the base station 3) identity, an indication of whether the re-establishment cell is the CHO candidate cell (in this example: no), one or more CHO candidate cell identifiers, number of CHO candidate cells, a trigger condition of CHO execution, a reference condition of CHO target selection.

In step 1026, the base station 4 1010 may send RLF indication to the base station 3 1008 to carry content of the RLF-report.

In step 1028, base station 3 1008 may send a message (such as HO REPORT) to the base station 1 to carry the content of the RLF-Report.

### Example Embodiment 8

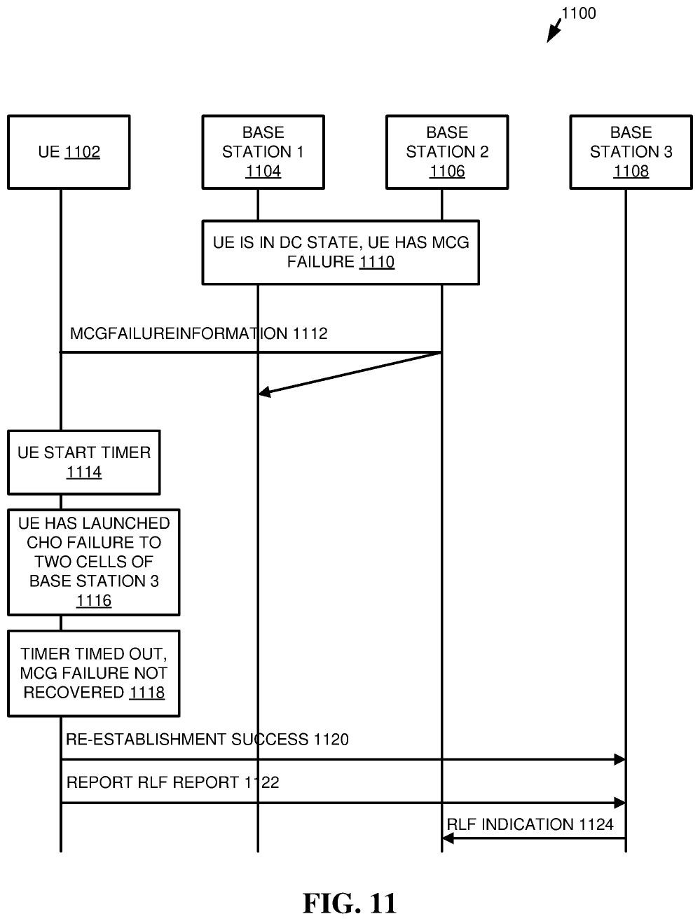

FIG. 11 illustrates a signaling process 1100 for performing network analysis according to an eighth example embodiment. As shown in FIG. 11, RLF and MCG recovery may fail.

In step 1110, the UE may be in the DC state, the cell 1 of base station 1 may be the PCell, the cell 2 of base station 2 may be the PSCell, and the UE in cell 1 may be in place the RLF. The UE may be in the DC state and the UE may have MCG failure.

In step 1112, the UE 1102 may send an MCG failure information message to base station 1 1004 via base station 2 1006. MCG failure information may include at least one of the following: MCG failure cause (in this case: the RLF), one or more CHO candidate cell identification, number of CHO candidate cells, a trigger condition of CHO execution, a reference condition of CHO target selection.

In step 1114, UE may start the configured timer.

In step 1116, UE initiates a CHO to the cell 3 and the cell 4 of the base station 3. The UE may have launched CHO failure to two cells of base station 3.

In step 1118, when the timer expires, the UE MCG failure may not be restored.

In step 1120, the UE may initiate a re-establishment to the cell 5 of the base station 3 and succeed.

In step 1122, the UE may report the RLF-report to the base station 3. The RLF-Report may include at least one of the following: Connection Failure Type (in this case: the MCG Recovery failure), RLF Cause (in this case: the MCG Recovery failure), indication whether occurring the MCG recovery failure (in this case: yes), MCG recovery failure cause (in this case: the MCG Recovery Timer timeout), MCG failure cause (in this case: the RLF), MCG Recovery Timer duration, identification of the handover target cell during the MCG recovery (in this case: the cell 3 and cell 4 of base station 3), indication whether the handover target cell during the MCG recovery is a CHO candidate cell (in this case: cell 3 and cell 4 are yes), MCGFailureInformation reported solution (in this case: using Duplicated messages), MCGFailureInformation reported SRB (in this case: through the MCG leg of split SRB1 and

SRB3), re-establishment cell (in this example, the cell 5 of the base station 3) identifier, an indication of whether the re-establishment cell is the CHO candidate cell (in this example: no), one or more CHO candidate cell identifiers, the number of CHO candidate cells, a trigger condition of CHO execution, a reference condition of CHO target selection.

In step 1124, base station 3 may send a message (such as RLF INDICATION) to the base station 1 to carry the content of the RLF-Report.

### Example Embodiment 9

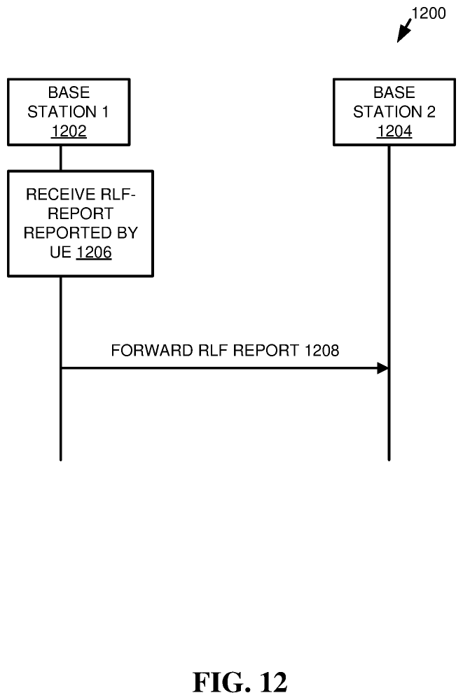

FIG. 12 illustrates a signaling process 1200 for performing network analysis according to a ninth example embodiment.

In step 1206, base station 1 1202 may receive RLF-report reported by a UE.

In step 1208, when rlf-Report contains the handover source cell, base station 1 forwards an RLF report (e.g., by RLF INDICATION message) to the base station serving the handover source cell (referred to as base station 2).

### Example Embodiment 10

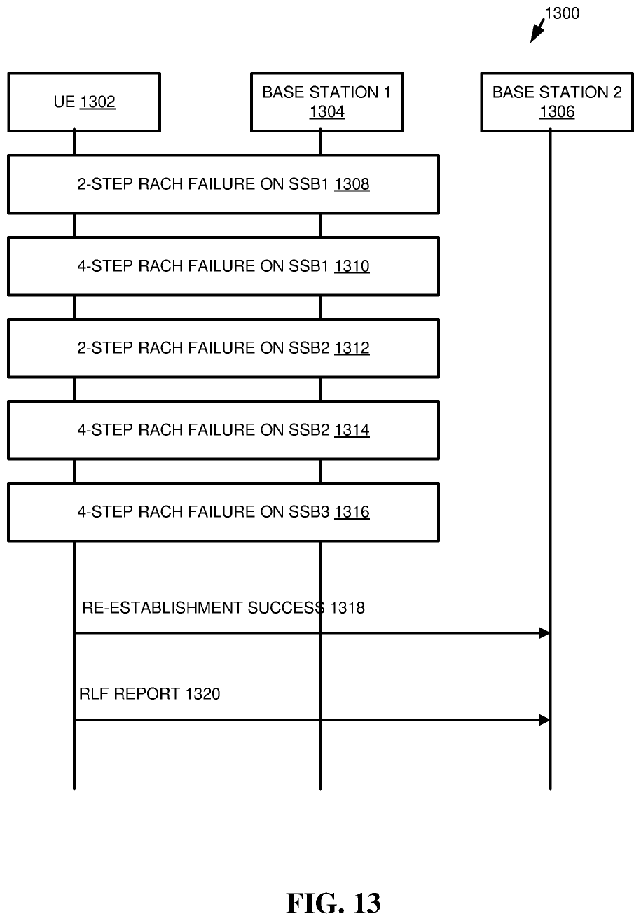

FIG. 13 illustrates a signaling process 1300 for performing network analysis according to a tenth example embodiment.

In step 1308, UE to the cell 1 of base station 1 may initiate a random access channel (RACH) procedure, where UE may perform a 2-step RACH attempt on SSB1 and fail.

In step 1310, UE may have fallback on SSB1, perform 4-step RACH attempt, and fail.

In step 1312, UE may have 2-step RACH attempt on SSB2 and fail.

In step 1314, UE may have fallback on SSB2, perform 4-step RACH attempt, and fail.

In step 1316, UE may perform 4-step RACH attempt on SSB3, and fail, where UE may occur RLF in cell 1.

In step 1318, UE may select the cell 2 of base station 2 for Cell Selection, the UE may initiate Re-establishment and successfully access base station 2.

In step 1320, UE RLF-Report may include at least one of the following: number of fallback between 2-step RACH and 4-step RACH per RACH procedure (This example is: 3 times), number of fallback between 2-step RACH and 4-step RACH per Beam (In this example: 1 times on SSB1, 1 times on SSB2, 1 times on SSB3), an indicator to indicate fallback between 2-step RACH and 4-step RACH per RACH procedure (This example is: True), and an indicator to indicate fallback between 2-step RACH and 4-step RACH per Beam (In this example: True on SSB1, True on SSB2, True on SSB3).

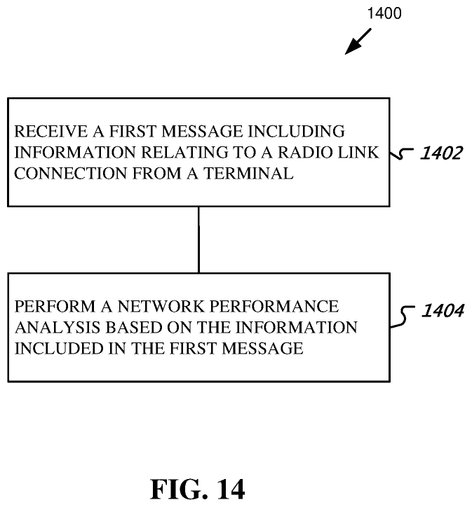

FIG. 14 illustrates a block diagram of a method to analyze network performance. The method may include receiving, by a network node, a first message including information relating to radio link connection from a terminal (block 1402). The first message may be a SCG failure information message, MCG failure information message, or UE information response message as described in the present embodiments.

The method may also include performing, by the network node, a network performance analysis based on the information included in the first message (block 1404).

In some embodiments, the first message includes information relating to conditional handover.

In some embodiments, the information relating to conditional handover includes one or more conditional handover candidate cell identifiers.

In some embodiments, the information relating to conditional handover includes number of conditional handover candidate cells.

In some embodiments, the information relating to conditional handover includes a trigger condition of CHO execution.

In some embodiments, the information relating to conditional handover includes a reference condition of CHO target selection (i.e. reference condition UE considers when UE selects the CHO execution target from multiple CHO candidate cells).

In some embodiments, the first message includes information relating to secondary cell group (SCG).

In some embodiments, the information relating to SCG includes an indication that a primary SCG cell of a secondary node for SN addition is a conditional handover candidate cell.

In some embodiments, the information relating to SCG includes an identifier of a primary SCG cell of a secondary node.

In some embodiments, the information relating to SCG includes an indication that a target primary SCG cell of a secondary node for SN change is a conditional handover candidate cell.

In some embodiments, the information relating to the SCG includes an identifier of a target primary SCG cell of a secondary node.

In some embodiments, the first message includes information relating to master cell group (MCG).

In some embodiments, the information relating to MCG includes an indication of whether a target primary cell for master node handover is a candidate cell.

In some embodiments, the information relating to MCG includes an MCG failure cause.

In some embodiments, the information relating to MCG includes an identifier of a target primary cell for master node handover.

In some embodiments, the first message includes information relating to connection failure.

In some embodiments, the information relating to the connection failure includes an identifier of a target cell for handover.

In some embodiments, the information relating to the connection failure includes an indication of a master cell group failure cause.

In some embodiments, the information relating to the connection failure includes an identifier of a target primary cell for master node handover.

In some embodiments, the information relating to the connection failure includes an indication of whether the target cell for handover is a conditional handover candidate cell.

In some embodiments, the information relating to the connection failure includes an indication of whether the target primary cell for master node handover is a conditional handover candidate cell.

In some embodiments, the information relating to the connection failure includes an identifier of a target primary secondary cell group cell (PSCell) of a secondary node.

In some embodiments, the information relating to the connection failure includes an indication of whether a target PSCell of a secondary node for SN change is a conditional handover candidate cell.

In some embodiments, the information relating to the connection failure includes a connection failure type, and a value of the connection failure type is indicative of master cell group recovery failure.

In some embodiments, the information relating to the connection failure includes a radio link failure cause, and a value of the radio link failure cause is indicative of master cell group recovery failure.

In some embodiments, the information relating to the connection failure includes an indication of whether a master cell group recovery failure has occurred.

In some embodiments, the information relating to the connection failure includes a cause for a master cell group recovery failure.

In some embodiments, the information relating to the connection failure includes a master cell group recovery timer duration.

In some embodiments, the information relating to the connection failure includes an identity of a handover target cell during a master cell group recovery process.

In some embodiments, the information relating to the connection failure includes an indication of whether a handover target cell during a master cell group recovery process is a conditional handover candidate cell.

In some embodiments, the information relating to the connection failure includes a master cell group (MCG) failure information reported solution.

In some embodiments, the information relating to the connection failure includes an MCG failure information reported path.

In some embodiments, the information relating to the connection failure includes a re-establishment cell identifier.

In some embodiments, the information relating to the connection failure includes an MCG failure information reported signaling radio bearer (SRB).

In some embodiments, the information relating to the connection failure includes an indication of whether the re-establishment cell is a conditional handover candidate cell.

In some embodiments, the first message includes information relating to random access channel (RACH) procedure including one or more RACH attempts.

In some embodiments, the information relating to RACH procedure includes a fallback number between a 2-step RACH attempt and a 4-step RACH attempt per RACH procedure.

In some embodiments, wherein the information relating to RACH procedure includes a fallback number between a 2-step RACH attempt and a 4-step RACH attempt per beam.

In some embodiments, the information relating to RACH procedure includes an indicator indicating fallback between a 2-step RACH attempt and a 4-step RACH attempt per RACH procedure.

In some embodiments, the information relating to RACH procedure includes an indicator indicating fallback between a 2-step RACH attempt and a 4-step RACH attempt per beam.

In some embodiments, the information relating to RACH procedure includes number of physical uplink shared channel (PUSCH) transmission occasions (PO) selected per beam.

In some embodiments, the information relating to RACH procedure includes a PO index selected per beam.

In some embodiments, the information relating to RACH procedure includes an indication of whether a maximum transmission power is used for transmission of a PUSCH payload for a 2-step RACH attempt per RACH procedure.

In some embodiments, the information relating to RACH procedure includes an indication of whether a maximum transmission power is used for transmission of a PUSCH payload for a 2-step RACH attempt per beam.

In some embodiments, the information relating to RACH procedure includes a maximum power level for transmission of a PUSCH payload for a 2-step RACH attempt per RACH procedure.

In some embodiments, the information relating to RACH procedure includes a maximum power level used for transmission of a PUSCH payload for a 2-step RACH attempt per beam.

In some embodiments, the information relating to RACH procedure includes an indication of whether the maximum transmission power is used for transmission of a PUSCH payload for a 2-step RACH attempt per PO.

In some embodiments, the information relating to RACH procedure includes number of power ramping in each PO for transmission of PUSCH payload of 2-step RACH.

In some embodiments, the information relating to RACH procedure includes number of preamble transmission power ramping on each beam.

In some embodiments, the information relating to RACH procedure includes a maximum power level for transmission of a PUSCH payload of a 2-step RACH attempt per PUSCH transmission occasion.

In some embodiments, the information relating to RACH procedure includes a maximum preamble transmission power on each beam.

In some embodiments, the information relating to RACH procedure includes 2-step RACH related information and/or 4-step RACH related information (in case that 2-step RACH and 4-step RACH is supported simultaneously, two separated Information Elements (IEs) may be used to include 2-step RACH related information and 4-step RACH related information, where a 2-step RACH related IE includes RACH procedure related information when 2-step RACH resource is used (if available), while 4-step RACH related IE includes RACH procedure related information when 4-step RACH resource is used (if available)).

In some embodiments, the 2-step RACH related information includes at least one of number of fallback between 2-step RACH and 4-step RACH per RACH procedure, number of fallback between 2-step RACH and 4-step RACH per Beam, an indicator to indicate Fallback Between 2-step RACH and 4-step RACH Per RACH procedure (which may be set to true if 2-Step RACH at least fallback to 4-step RACH once during a RACH procedure), an indicator to indicate fallback between 2-step RACH and 4-step RACH per Beam (which may be set to true if 2-step RACH at least fallback to 4-step RACH once related to a Beam During a RACH procedure), number of PUSCH transmission occasion (PO) selected per Beam, a PO index selected per Beam (Listed in chronological order of attempts), an indicator to indicate whether the maximum transmission power is used for transmission of PUSCH payload of 2-step RACH per RACH procedure, an indicator to indicate whether the maximum transmission power is used for transmission of PUSCH payload of 2-step RACH per PO, and an indicator to indicate whether the maximum transmission power is used for transmission of PUSCH payload of 2-step RACH per Beam (for example, if the maximum transmission power is used for transmission of PUSCH payload of 2-step RACH in at least one PO mapped to this Beam, where the maximum transmission power is used for this Beam), a maximum power level used for transmission of PUSCH payload of 2-step RACH per RACH procedure, a maximum power level used for transmission of PUSCH payload of 2-step RACH per PO, a maximum power level used for transmission of PUSCH payload of 2-step RACH per Beam (in case Multiple PO is mapped to One Beam, it may be a list of maximum power level in Each PO, or the maximum power level among all PO), number of power ramping in each PO for transmission of PUSCH payload of 2-step RACH, number of preamble transmission power ramping on each beam, and a maximum preamble transmission power on each beam, number of fallback between 2-step CFRA to 2-step CBRA per RACH procedure, number of fallback between 2-step CFRA to 2-step CBRA per beam, number of preambles sent on each beam and the beam indices, indexes of tried beams and number of preambles sent on each tried beam listed in chronological order of attempts, contention detected indication per beam (wherein the contention detected indication is set as true if at least one failed contention resolution is detected in this beam), backoff related information (e.g. number of backoff with value larger than 0 used during RACH attempt utilizing RACH resource configured for 2-step RACH, or list of backoff value used during RACH attempt utilizing RACH resource configured for 2-step RACH, or maximum backoff value used during RACH attempt utilizing RACH resource configured for 2-step RACH), number of preambles sent in each preamble group per RACH procedure, number of preambles sent in each preamble group per beam, indication to indicate which group of preamble is selected per RACH procedure (such group A, group B, or both), indication to indicate which group of preamble is selected per beam (such group A, group B, or both), indication to indicate which type of beam is selected per RACH procedure (such as SSB, CSI-RS, or both), list of type of beam selected in chronological order per RACH procedure.

In some embodiments, the 4-step RACH related information includes at least one of number of preamble transmission power ramping on each beam, maximum preamble transmission power on each beam, number of fallback between CFRA to 4-step CBRA per RACH procedure, number of fallback between CFRA to 4-step CBRA per beam, number of preambles sent on each beam and the beam indices, indexes of tried beams and number of preambles sent on each tried beam listed in chronological order of attempts, contention detected indication per beam (wherein the contention detected indication is set as true if at least one failed contention resolution is detected on this beam), backoff related information (e.g. number of backoff with value larger than 0 used during RACH attempt utilizing RACH resource configured for 4-step RACH, or list of backoff value used during RACH attempt utilizing RACH resource configured for 4-step RACH, or maximum backoff value used during RACH attempt utilizing RACH resource configured for 4-step RACH), number of preambles sent in each preamble group per RACH procedure, number of preambles sent in each preamble group per beam, indication to indicate which group of preamble is selected per RACH procedure (such group A, group B, or both), indication to indicate which group of preamble is selected per beam (such group A, group B, or both), indication to indicate which type of beam is selected per RACH procedure (such as SSB, CSI-RS, or both), list of type of beam selected in chronological order per RACH procedure.

In some embodiments, the method includes receiving, by the network node, a secondary cell group failure information message from the terminal, the secondary cell group failure information message including information relating to secondary cell group and/or information relating to conditional handover.

In some embodiments, the method includes receiving, by the network node, a master cell group failure information message from the terminal, the master cell group failure information message including information relating to master cell group and/or information relating to conditional handover.

In some embodiments, the first message is a user equipment (UE) information response message that includes connection failure related information, conditional handover related information, and/or random access channel related information.

In some embodiments, the method includes responsive to receiving the first message, forwarding, by the network node, a second message to a secondary node, the second message including any of secondary cell group information and/or conditional handover information, the network node including a master node.

In some embodiments, the method includes responsive to receiving the first message, forwarding, by the network node, a second message including any of connection failure related information, conditional handover information, and random access channel related information, to another network node serving a source cell associated with handover.

In some embodiments, the method includes responsive to receiving the first message, forwarding, by the network node, a second message including any of connection failure related information, conditional handover information, and random access channel related information, to another network node serving a cell in which a connection failure occurred.

In some embodiments, the network node serving a cell in which a connection failure occurred forwards the received information including at least one of information relating to connection failure, information relating to conditional handover, and information relating to RACH procedure to another network node serving a source cell associated with handover.

In some embodiments, the network performance analysis is performed by a network node serving a cell in which a connection failure occurred.

In some embodiments, the network node includes a secondary node, wherein the secondary node performs the network performance analysis.

In some embodiments, the network performance analysis is performed by a network node serving a source cell associated with handover.

Wireless Communication System

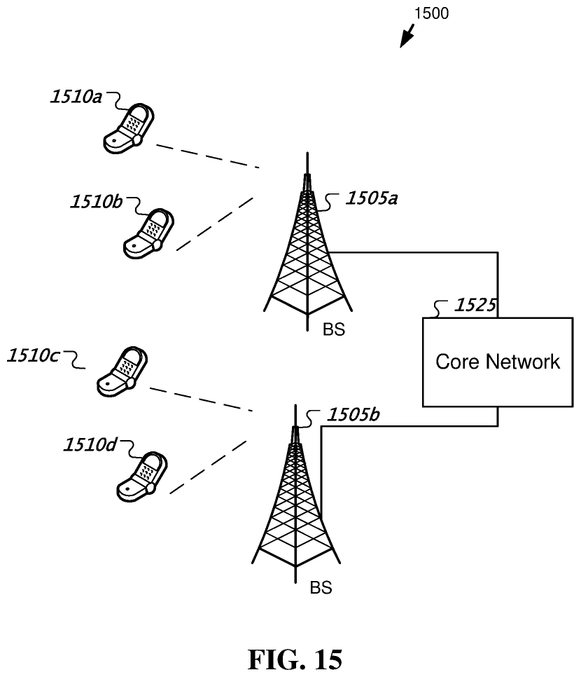

FIG. 15 shows an example of a wireless communication system where techniques in accordance with one or more embodiments of the present technology can be applied. A wireless communication system 1500 can include one or more base stations (BS s) 1505a, 1505b, one or more wireless devices 1510a, 1510b, 1510c, 1510d, and a core network 1525. A base station 1505a, 1505b can provide wireless service to wireless devices 1510a, 1510b, 1510c and 1510d in one or more wireless sectors. In some implementations, a base station 1505a, 1505b includes directional antennas to produce two or more directional beams to provide wireless coverage in different sectors.

The core network 1525 can communicate with one or more base stations 1505a, 1505b. The core network 1525 provides connectivity with other wireless communication systems and wired communication systems. The core network may include one or more service subscription databases to store information related to the subscribed wireless devices 1510a, 1510b, 1510c, and 1510d. A first base station 1505a can provide wireless service based on a first radio access technology, whereas a second base station 1505b can provide wireless service based on a second radio access technology. The base stations 1505a and 1505b may be co-located or may be separately installed in the domain according to the deployment scenario. The wireless devices 1510a, 1510b, 1510c, and 1510d can support multiple different radio access technologies. In some embodiments, the base stations 1505a, 1505b may be configured to implement some techniques described in the present document. The wireless devices 1510a to 1510d may be configured to implement some techniques described in the present document.

In some implementations, a wireless communication system can include multiple networks using different wireless technologies. A dual-mode or multi-mode wireless device includes two or more wireless technologies that could be used to connect to different wireless networks.

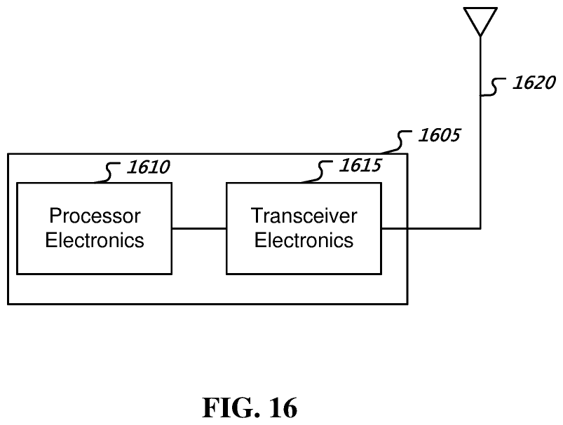

FIG. 16 is a block diagram representation of a portion of a hardware platform. The communication node as described in the present application may include the hardware platform as described with respect to FIG. 16. A hardware platform 1605 such as a network device or a base station or a wireless device (or UE) can include processor electronics 1610 such as a microprocessor that implements one or more of the techniques presented in this document. The hardware platform 1605 can include transceiver electronics 1615 to send and/or receive wired or wireless signals over one or more communication interfaces such as antenna 1620 or a wireline interface. The hardware platform 1605 can implement other communication interfaces with defined protocols for transmitting and receiving data. The hardware platform 1605 can include one or more memories (not explicitly shown) configured to store information such as data and/or instructions. In some implementations, the processor electronics 1610 can include at least a portion of the transceiver electronics 1615. In some embodiments, at least some of the disclosed techniques, modules or functions and network nodes are implemented using the hardware platform 1605.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for enforcement by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an enforcement environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (domain programmable gate array) or an ASIC (application specific integrated circuit).

Processors suitable for the enforcement of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

1-42. (canceled)

43. A method for wireless communication, comprising:
transmitting, by a network node, a request for user equipment information;
receiving, by the network node, a first message including information relating to radio link connection from a terminal, the first message corresponding to the request for the user equipment information; and
performing, by the network node, a network performance analysis based on the information relating to radio link connection.

44. The method of claim 43, wherein the information relating to the radio link connection includes information relating to conditional handover (CHO) that includes at least one of one or more conditional handover candidate cell identifiers or a reference execution condition for CHO target selection.

45. The method of claim 43, wherein the information relating to the radio link connection includes information relating to condition handover (CHO) including a trigger condition of CHO execution that includes at least one of a type of the reference signal, a measurement quantity of the reference signal, or a comparison rule.

46. The method of claim 45, wherein the type of the reference signal includes a reference beam type indicating whether it is a synchronization signal block (SSB) or channel state information reference signal (CSI-RS) and the measurement quantity of the reference signal includes reference signal received power (RSRP) value, reference signal received quality (RSRQ) value, or signal-to-noise and interference ratio (SINR) value.

47. The method of claim 45, wherein the comparison rule compares only a best beam, or compares a plurality of beams above a threshold, or a threshold.

48. The method of claim 43, wherein the information relating to the radio link connection includes information relating to connection failure that includes at least one of an indication of whether the target cell for handover is a conditional handover candidate cell, an indication of whether the target primary cell for master node handover is a conditional handover candidate cell, an indication of whether a target PSCell of a secondary node for SN change is a conditional handover candidate cell, or an indication of whether the re-establishment cell is a conditional handover candidate cell.

49. The method of claim 43, wherein the information relating to the radio link connection includes information relating to random access channel (RACH) procedure including one or more RACH attempts, and wherein the information relating to RACH procedure includes at least one of, an indication of whether a maximum transmission power is used for transmission of a PUSCH payload for a 2-step RACH attempt per RACH procedure, an indication of whether a maximum transmission power is used for transmission of a PUSCH payload for a 2-step RACH attempt per beam, a maximum power level for transmission of a PUSCH payload for a 2-step RACH attempt per RACH procedure, a maximum power level used for transmission of a PUSCH payload for a 2-step RACH attempt per beam, or a number of preamble transmission power ramping on each beam.

50. The method of claim 43, wherein the information relating to the radio link connection includes at least one of the following: an indicator to indicate fallback between 2-step RACH and 4-step RACH per beam, an indication to indicate which group of preamble is selected per RACH procedure, an indication to indicate which group of preamble is selected per beam, a list of type of beam selected in chronological order per the RACH procedure, the number of preambles sent on each beam and the beam indices, indexes of tried beams, the number of preambles sent on each tried beam listed in chronological order of attempts, or contention detected indication per beam or backoff related information.

51. The method of claim 43, wherein the first message is a user equipment (UE) information response message that further includes connection failure related information.

52. The method of claim 43, further comprising:
responsive to receiving the first message, forwarding, by the network node including a master node to a secondary node, a second message including conditional handover related information.

53. The method of claim 43, further comprising:
responsive to receiving the first message, forwarding, by the network node, a second message including connection failure related information, to another network node serving a source cell associated with handover or to another network node serving a cell in which a connection failure occurred.

54. A method for wireless communication, comprising:
receiving, by a network node from a terminal, an information message corresponding to a master cell group failure event; and
performing, by the network node, a network performance analysis based on the information relating to radio link connection, and
wherein the information relating to the radio link connection includes at least one of a connection failure type with a value indicative of master cell group recovery failure, a radio link failure cause with a value indicative of master cell group recovery failure, an indication of whether a master cell group recovery failure has occurred, a cause for a master cell group recovery failure, a master cell group recovery timer duration, an indication of whether a handover target cell during a master cell group recovery process is a conditional handover candidate cell, or an MCG failure information reported signaling radio bearer (SRB) type.

55. The method of claim 54, wherein the information message is a master cell group (MCG) failure information or UE (User Equipment) information response in responsive to request from the network node.

56. The method of claim 54, wherein the cell group failure information message includes information relating to conditional handover.

57. The method of claim 54, wherein the information relating to radio link connection includes information relating to master cell group (MCG) that includes an indication of whether a target primary cell for master node handover is a candidate cell.

58. The method of claim 54, wherein the network node includes a master node or a secondary node.

59. The method of claim 54, wherein the information relating to the radio link connection includes information relating to conditional handover (CHO) that includes at least one of one or more conditional handover candidate cell identifiers or a reference execution condition for CHO target selection.

60. The method of claim 54, wherein the information relating to the radio link connection includes information relating to condition handover (CHO) including a trigger condition of CHO execution that includes at least one of a type of the reference signal, a measurement quantity of the reference signal, or a comparison rule.

61. The method of claim 54, wherein the information relating to the radio link connection includes information relating to connection failure that includes at least one of an indication of whether the target cell for handover is a conditional handover candidate cell, an indication of whether the target primary cell for master node handover is a conditional handover candidate cell, an indication of whether a target PSCell of a secondary node for SN change is a conditional handover candidate cell, or an indication of whether the re-establishment cell is a conditional handover candidate cell.
